(19) United States
(12) Patent Application Publication
(10) Pub. No.: US 2009/0184932 A1
(43) Pub. Date: Jul. 23, 2009

(54) Portable Device Capable of Initiating Disengagement from Host System

(75) Inventor: Brett Gregory Alten, Cupertino, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 12/017,978

(22) Filed: Jan. 22, 2008

(51) Int. Cl. G06F 3/041

(52) U.S. Cl. 345/173

(57) ABSTRACT

A portable device configured for engaging to a host system can be operable to generate a signal when the portable device is touched by a user or when the portable device detects an impending touch by the user. Responsive to the signal, the host system automatically initiates one or more operations related to disengaging the portable device from the host system.

### TECHNICAL FIELD

This subject matter is generally related to portable devices.

### BACKGROUND

Some portable devices (e.g., USB Flash Drive) can be mounted as a hard drive volume onto a host system (e.g., a personal computer). When the user connects the device to a port, an operating system running on the host system automatically detects the connected device, mounts the device as a hard disk volume and creates an icon for the device which is typically presented on a desktop user interface of the host system. The user can then interact with the device (e.g., read/write data) like any other peripheral device connected to the host system.

Before the user can remove the device, the user has to tell the host system that the device is about to be disconnected, so that an operating system of the host system can perform dismount operations (e.g., finish read/write transactions, close files) to prevent data loss when the device is disconnected from the host system. Some popular operating systems (e.g., Mac OS®, Windows®) require the user to “drag n drop” the icon onto a “trash” icon or perform some other sequence of steps to warn the operating system that the device is about to be disconnected. This conventional dismount procedure allows the operating system to perform dismount operations before the device is disconnected from the host system.

A common problem with conventional dismount procedures is that users often forget to follow the dismount procedures. For users who remember to use the proper dismount procedures, there is often a long wait while the operating system performs dismount operations. This wait can be several seconds long which can be frustrating to many users.

### SUMMARY

A portable device configured for engaging to a host system can be operable to generate a signal when the device is touched by a user or when the portable device detects an impending touch by the user. Responsive to the signal, the host system automatically initiates one or more operations related to disengaging the portable device from the host system. In some aspects, the portable device can be electrically, optically, electromechanically and/or mechanically engaged and/or disengaged to a host system.

These features allow a user to disconnect the portable device from the host system more quickly, and also prevents data corruption due to failure of the user to follow proper procedures.

### DESCRIPTION OF DRAWINGS

FIG. 1 is a block diagram of an example system including a portable device and a host system.

FIG. 2 is a block diagram of an example capacitive-sensing system for generating a signal in response to touch input.

FIG. 3 is a block diagram of an example host system process for initiating one or more operations in response to touch input.

FIGS. 4A-4B are flow diagrams of example portable device processes for generating a signal in response to touch input.

FIG. 5 is a flow diagram of an example host system for implementing the features and operations described in reference to FIG. 1-4.

### DETAILED DESCRIPTION

### System Overview

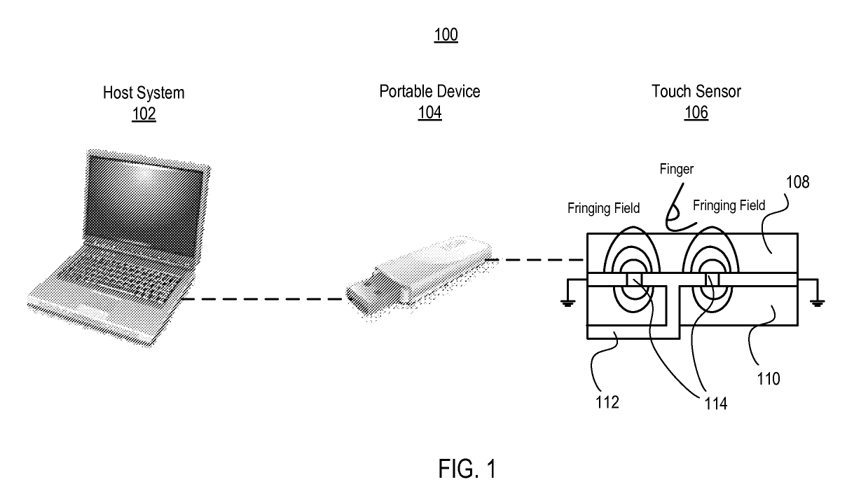

FIG. 1 is a block diagram of example system 100 which can include host system 102 and a portable device 104. Host system 102 can be any device capable of coupling to a portable device 104. Some examples of host systems can include but are not limited to: personal computers, mobile phones, media players, email devices, game consoles, etc. Portable device 104 can be any device with the ability to detect or respond to human touch. Some examples of portable devices include but are not limited to: Universal Serial Bus (USB) flash drives, SD cards, mobile phones, media players, game consoles, computer peripherals, biometric sensors, keypads, headsets, time pieces or other wearable items, pointing devices, computer input devices, touch pads, touch screens, key chains, multi-touch surfaces, etc. Host system 102 and portable device 104 can be coupled together using a variety of known technologies (e.g., USB, FireWire®, n-pin connector).

In the example shown, portable device 104 is a USB flash drive that can connect to a USB port on host system 102. Portable device 104 can include touch sensor 106. In the example shown, touch sensor 106 is a capacitive sensor. Other touch sensors can also be used, including but not limited to: resistive, surface acoustic wave, infrared, strain gauge, optical imaging, dispersive signal technology, acoustic pulse recognition, frustrated total internal reflection, etc. In some implementations, more than one touch sensor 106 can be used in a single portable device 104.

In the example shown, touch sensor 106 can be a capacitive-sensing system, which includes sensor 108 (e.g., a Pyrex® glass overlay) mounted on printed circuit board (PCB) 110 (e.g., made from FR4 material). PCB 110 can include conductors 114 for generating fringing electric fields. Placing a finger near a fringing electric field adds conductive surface area to the capacitive-sensing system. The finger's capacitance adds additional charge storage capacity to the capacitive-sensing system which can be detected. Printed circuit traces 112 (e.g., copper traces) can electrically connect conductors 114 to an energy source. Traces 112 can be designed to direct the fringing fields into sensor 108, so the fringing fields are accessible by one or more fingers of a user. In some implementations, the fringing fields can be designed to allow touch detection when the user's finger is proximate sensor 108 but not actually touching sensor 108. This allows detection of an impending touch.

In some implementations, portable device 104 can include a mechanical actuator (e.g., a switch, button) that can be manipulated by a user to engage and/or disengage portable device 104 from host system 102. For example, mechanical actuation (e.g., pressing a button) can initiate a touch signal for initiating disengagement (e.g., electrical, optical, electromechanical, electromagnet, mechanical) of portable device 104 from host system 102.

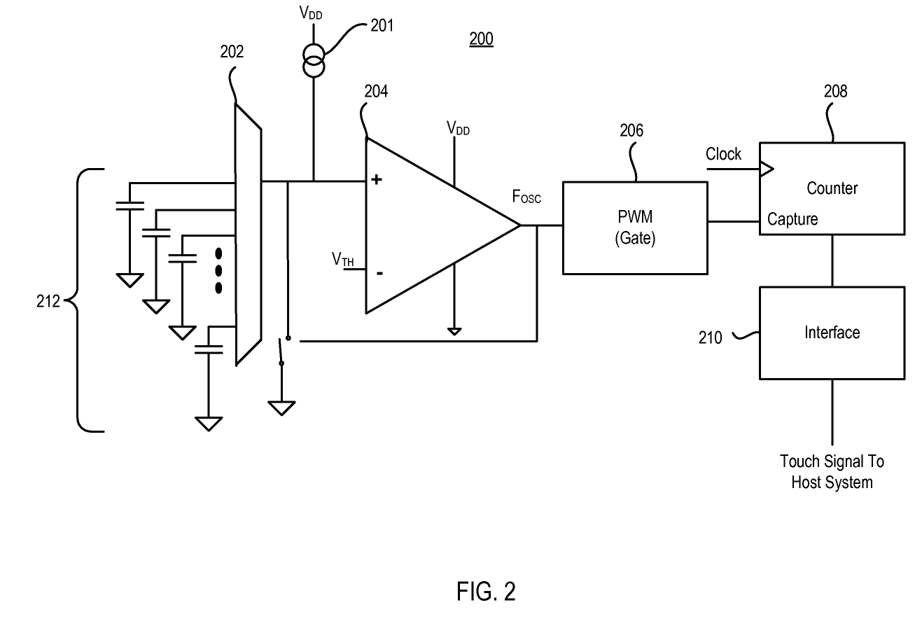

Thus touch input can be generated by a touch sensitive system (e.g., a capacitive-sensitive system) or by mechanical force. Although the following description refers to a capacitive-sensing system, the disclosed implementations are equally applicable to mechanical actuators (e.g., mechanical buttons). Touch input can be generated by physical contact with a surface or mechanism or by proximity to a surface or mechanism, such as with capacitive-sensing system 200, as described in reference to FIG. 2.

### Portable Device Circuit

FIG. 2 is a block diagram of example capacitive-sensing system 200 for generating a signal in response to touch input. In some implementations, system 200 can include programmable current source 201, analogue multiplexer 202, precision analog comparator 204, pulse width modulator (PWM) circuit 206, counter 208 (e.g., a 16-bit counter), interface 210 (e.g., a USB interface) and array of capacitive sensors 212. These components form a relaxation oscillator which provides the capacitive sensing in system 200. System 200 can be tuned by selecting a level (e.g., 200 out of 255 levels) of a digital-to-analog converter (DAC) of the current source, and setting the number of oscillator cycles to accumulate counts. Additional circuitry (e.g., a processor and firmware) can be added to system 200 to account for noise (e.g., drift, bounce).

In operation, the output of comparator 204 can be fed into a clock input of PWM circuit 206, which gates counter 208. In the example shown, counter 208 can be a 16-bit counter which can be clocked at about 24 MHz. Array of capacitive sensors 212 can generate fringing electric fields which can penetrate a surface or housing of portable device 104. A finger interacting with the fringing electric fields can cause the capacitance of array 212 to increase, which can cause the counts to increase. In some implementations, the count (or count difference) can be stored in a buffer in interface 210 so that it can be compared to a count threshold using a processor and/or circuitry (e.g., a decoder, a comparator). The count threshold (e.g., 60 counts) can be determined empirically. Additional counts (e.g., 10 counts) can be added to the count threshold to account for noise that may cause false triggers.

In some implementations, interface 210 includes circuitry (e.g., a processor, logic) for detecting a count change (e.g., a count increase) and generates a touch signal. For example, the count change can be detected by gating a carry out bit or other output(s) of counter 208. In some implementations, interface 210 is a USB interface and the touch signal is conditioned for transfer to host system 102 using USB protocol. The operating system of host system 102 (or a media controller) can detect the touch signal and initiate one or more operations in response to the touch signal.

In some implementations, when portable device 104 is inserted into a port of host system 102 (e.g., a USB port), capacitive-sensing system 200 receives power from host system 102 through interface 210. In other implementations, however, device 104 can be self-powered (e.g., battery powered) or powered by a hub device. Portable device 104 can include a processor and firmware that can be operable for reading a count or count difference output from counter 208, and placing portable device 104 into an “armed” state after the user has released their grip on portable device 104. For example, firmware and/or circuitry can be configured to compare the count with a count threshold immediately after system 210 is powered up. If the user is touching portable device 104 after power up (e.g., the user has not yet released the portable device after insertion), system 200 does not generate a touch signal. If the count drops below the count threshold value (e.g., indicating that the user has released the device after insertion), device 104 enters an “armed” state. Arming portable device 104 can include setting an “armed” flag (e.g., one or more bits) in memory of portable device 104 and/or setting a circuit that has memory (e.g., a latch circuit) to indicate that portable device 104 is “armed.” If portable device 104 is “armed” and the count increases above the count threshold, then system 200 can generate a touch signal which can be detected by host system 102.

In some implementations, software and/or circuitry can be installed on host system 200 for detecting a touch signal. In such implementations, portable device 104 may send the count (or count difference) to host system 102 in response to: 1) a request from host system 102, 2) a trigger event on host system 102 and/or portable device 104, or 3) on a scheduled basis. When portable device 104 is first connected, portable device 104 can send host system 102 descriptor information identifying portable device 104 as a portable device. This information can enable host system 102 (e.g., a media controller) to configure itself to detect a touch signal.

In some implementations, the touch signal causes portable device 104 to change the electrical characteristics (e.g., change in impedance, resistance, current or voltage levels, capacitance, inductance) of the connection with host system 102 without portable device 104 being physically disconnected from host system 102. For example, for a USB compliant device, circuitry (e.g., a programmable resistor divider) in interface 210 can be programmed or otherwise modified to warn host system 102 that a touch has occurred or is impending. The change of electrical characteristics of the connection can be detected or sensed by circuitry in host system 102. Upon such detection or sensing, host system 102 can initiate the appropriate operations related to physical disconnection of device 104.

In some implementations, host system 102 and portable device 104 can be optically, mechanically or electromagnetically connected. In such implementations, portable device 104 and/or host system 102 can include suitable optical, mechanical or electromagnetic components.

In some implementations, the port on host system 102 and/or the device 104 can include a locking mechanism (e.g., magnetic lock, physical engagement) for preventing removal of portable device 104 from the port. The locking mechanism can be disengaged as an operation performed in response to the touch signal or a mechanical force (e.g., a mechanical button or switch is activated). One example of a magnetic locking mechanism is described in U.S. patent application Ser. No. ______, for “Electromagnetic Connector for Electrical Device,” Attorney Docket No. P3794US1/119-0060US.1, the subject matter of which is incorporated by reference herein in its entirety. In some implementations, portable device 104 can be magnetically coupled to host system 102 with a magnetic force which can be reduced to allow disengagement from host system 102. In some implementations, portable device 104 can include a biometric sensor for detecting a user's fingerprint. The fingerprint information can be used to lock down the host system or particular files from unauthorized users, or for any other security purposes.

In some implementations, portable device 104 can be mechanically coupled to host system 102 by a physical structure (e.g., one or more pins or other structures), which can be electromagnetically or mechanically controlled to lock portable device 104 to host system 102. Such a locking mechanism, or other suitable locking mechanisms, can be located on portable device 104, host system 102, or both.

### Example Host System Process

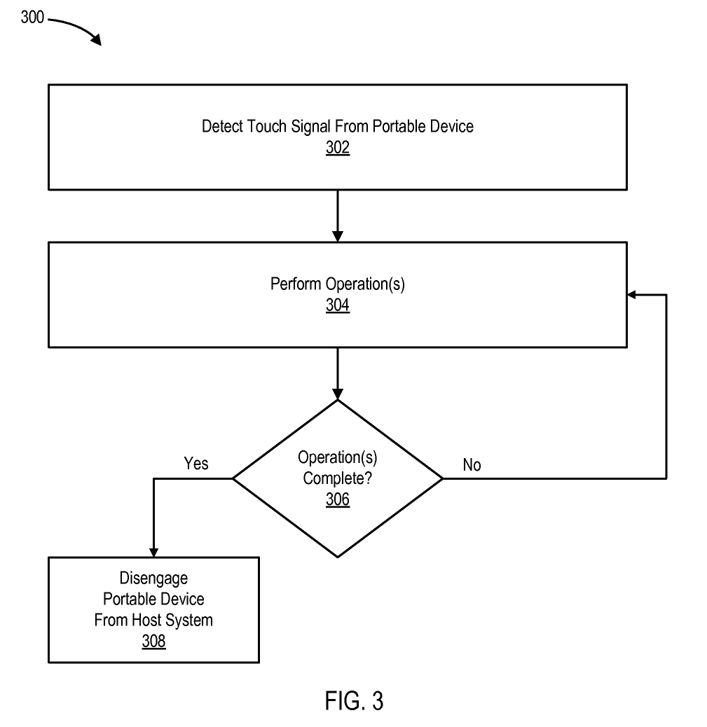

FIG. 3 is a block diagram of example host system process 300 for initiating one or more operations in response to touch input. In some implementations, process 300 begins when a touch signal is detected from portable device (302). The portable device can be a portable USB flash drive and the host system can be a personal computer, for example. The touch signal can be a data or control signal sent from the drive to the personal computer. The touch signal can be a change in electrical characteristics (e.g., change in impedance, resistance, current or voltage levels) in the connection between the host system and the portable device. For example, when the user touches the device housing, the circuitry in the device (e.g., a programmable resistor network) is programmed or otherwise altered (e.g., components are switched into and/or out of the circuitry) to change the electrical characteristics of the connection. The changes can be detected or sensed by circuitry in the host system (e.g., a sense resistor or sense capacitor). The touch signal can also be initiated by a mechanical device (e.g., actuator, button, switch, key, lever, pressure sensor).

In some implementations, when the host system receives or detects the touch signal, the host system performs (e.g., automatically) one or more operations on the host system and/or the device (304). Some examples of operations can include completing transactions (e.g., read/write requests to the device), closing applications or files, generating and presenting visual or audio feedback warnings to the user to wait for the operations to complete before disconnecting the device, etc. If the operations are complete (306), the portable device can be disengaged (e.g., automatically, electrically, optically, magnetically, physically) from the host system so that the user can safely remove the device (308).

### Example Portable Device Process

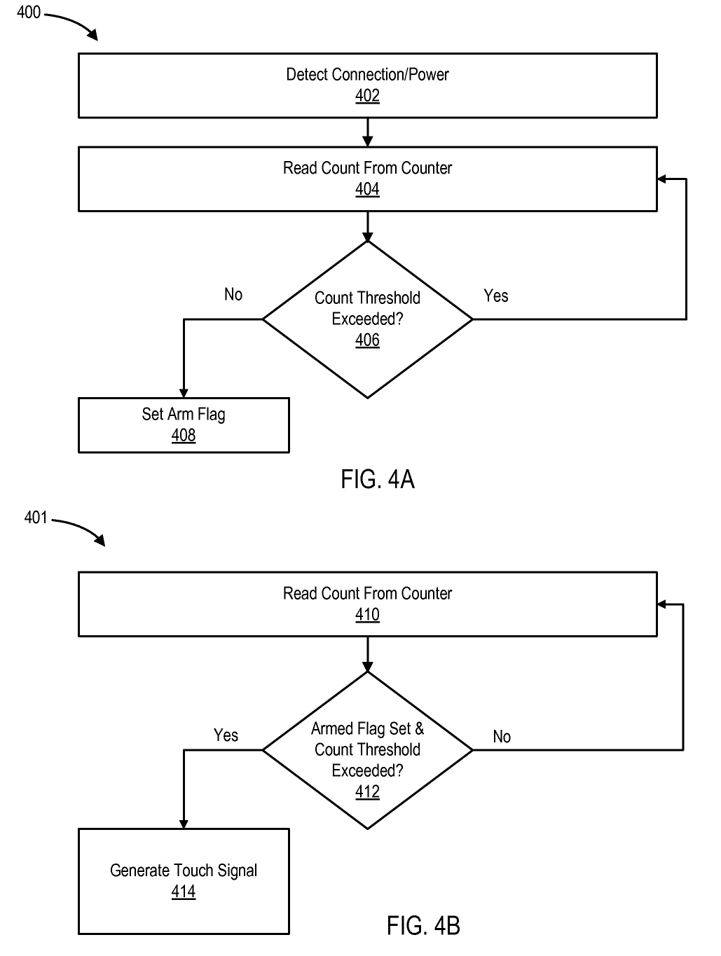

FIGS. 4A-4B are flow diagrams of example portable device processes 400, 401 for generating a signal in response to touch input. Processes 400 and 401 can be performed by a portable device having capacitive-sensing system 200. However, other touch sensors can be used to obtain similar results.

Referring to FIG. 4A, in some implementations, process 400 can begin when a connection and/or power is detected by the portable device (402). In a USB compliant device, a connection can be detected through the receipt of a signal from the host system. In some implementations, the portable device can electrically or otherwise detect or sense a connection with a host system by sensing, for example, a change in electrical characteristics of the connection with the host system (e.g., change in impedance, resistance, capacitance, inductance, current, voltage, mechanical actuation, etc.). In other implementations, optical or electromagnetic characteristics can be detected or sensed.

After the connected/power is detected, a count can be read from a counter (404) as described in reference to FIG. 2. The count can be read from a buffer by a processor in the portable device or by the host system. If the count exceeds a count threshold (406), then step 404 is repeated. If the count does not exceed the count threshold, then an alarm flag can be set (408). In some implementations, the alarm flag (e.g., one or more bits) can be stored in memory or a circuit (e.g., a latch) of the portable device and/or the host system.

Referring to FIG. 4B, in some implementations, process 401 can begin when the count is read from the counter (410). If the arm flag is set and the count exceeds the count threshold (412), a touch signal can be generated (414). Otherwise, step 410 can be repeated. The touch signal can be generated by circuitry in the portable device, as described in reference to FIG. 2.

### Example Host System Architecture

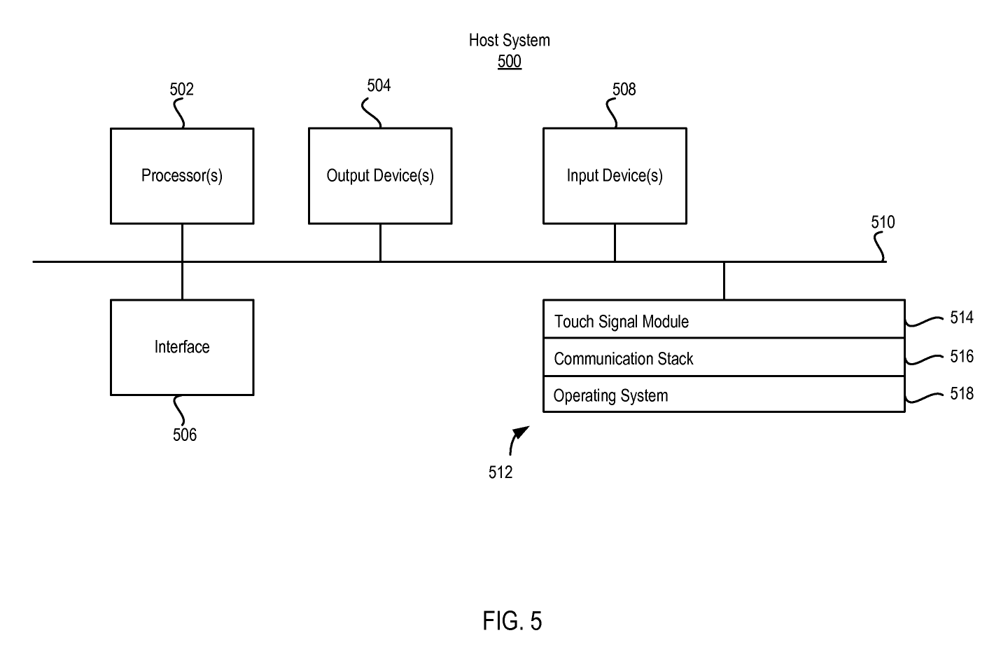

FIG. 5 is a block diagram of host system architecture 500 for implementing the features and operations described in reference to FIGS. 1-4. Other architectures are possible, including architectures with more or fewer components. In some implementations, architecture 500 can include one or more processors 502 (e.g., dual-core Intel® Xeon® Processors), one or more output devices 504 (e.g., LCD), one or more network interfaces 506 (e.g., USB ports, FireWire® ports, Ethernet), one or more input devices 508 (e.g., mouse, keyboard, touch-sensitive display) and one or more computer-readable mediums 512 (e.g., RAM, ROM, SDRAM, hard disk, optical disk, flash memory, etc.). These components can exchange communications and data over one or more communication channels 510 (e.g., buses), which can utilize various hardware and software for facilitating the transfer of data and control signals between components.

The term “computer-readable medium” refers to any medium that participates in providing instructions to processor 502 for execution, including without limitation, non-volatile media (e.g., optical or magnetic disks), volatile media (e.g., memory) and transmission media. Transmission media can include, without limitation, coaxial cables, copper wire and fiber optics. Transmission media can also take the form of acoustic, light or radio frequency waves.

Computer-readable medium 512 can further include operating system 518 (e.g., Mac OS® server, Windows® NT server), communication stack 516 and portable device client 514. Operating system 518 can be multi-user, multiprocessing, multitasking, multithreading, real time, etc. Operating system 518 performs basic tasks, including but not limited to: recognizing input from and providing output to devices 508, 504; keeping track and managing files and directories on computer-readable mediums 512 (e.g., memory or a storage device); controlling peripheral devices; and managing traffic on one or more communication channels 510. Communication stack 516 can include various components for establishing and maintaining communication connections (e.g., software for implementing communication protocols, such as USB 2.0, FireWire®, Ethernet, TCP/IP, HTTP, etc.). Touch signal module 514 can perform process 300 described in reference to FIG. 3 and in some implementations can be part of the communication stack 516.

Architecture 500 can also be included in any device capable of detecting a touch signal, including but not limited to: media players, mobile phones, smart phones, email devices, game consoles or devices, personal computers, personal digital assistants, etc. Architecture 500 can be implemented in a parallel processing or peer-to-peer infrastructure or on a single device with one or more processors. Software can include multiple software components or can be a single body of code.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining a touch signal from a portable device engaged with a host system, the touch signal indicative of the portable device being touched by a user or an impending touch by the user; and
responsive to the touch signal, initiating one or more operations related to disengaging the portable device from the host system.

2. The method of claim 1, where the disengaging is one of mechanical, physical, optical, magnetic, electromagnet or electrical disengagement.

3. The method of claim 1, where the disengaging further comprises:
performing one or more volume dismounting operations.

4. The method of claim 1, where the touch signal is initiated by a touch sensitive device.

5. The method of claim 1, where the touch signal is initiated by a mechanical device.

6. A method comprising:
detecting touch input at a portable device;
generating a signal indicative of the touch input; and
presenting the signal to a host system coupled to the portable device, where the signal is used to automatically initiate one or more operations related to disengaging the portable device from the host system.

7. The method of claim 6, where detecting touch input further comprises:
detecting a change in capacitance related to the touch input; and
generating the signal based on the change in capacitance.

8. The method of claim 7, where the touch input is initiated by a user without making physical contact with the portable device.

9. The method of claim 6, wherein the touch input is generated by a mechanical device.

10. The method of claim 6, where disengaging further comprises:
reducing a magnetic field used to engage the portable device with the host system.

11. The method of claim 6, where generating a signal indicative of the touch input, further comprises:
changing electrical characteristics of a connection between the portable device and the host system.

12. The method of claim 6, further comprising:
detecting a connection or power;
responsive to the detection of a connection or power, determining if the portable device is being touched; and
if the portable device is not being touched,
setting the portable device to detect touch input.

13. A portable device, comprising:
a touch sensor operable for detecting touch input at a portable device; and
an interface coupled to the touch sensor and including circuitry operable for generating a signal indicative of the touch input, and presenting the signal to a host system engaged to the portable device, where the signal is used to automatically initiate one or more operations related to disengaging the portable device from the host system.

14. The device of claim 13, where the touch sensor further comprises:
a capacitive-sensing system operable for detecting a change in capacitance related to the touch input; and
generating the signal based on the change in capacitance.

15. The device of claim 13, where the portable device is from a group of portable devices including: Universal Serial Bus (USB) flash drives, SD cards, mobile phones, media players, game consoles, computer peripherals, biometric sensors, keypads, headsets, time pieces or other wearable items, pointing devices, computer input devices, touch pads, touch screens, key chains and multi-touch surfaces.

16. The device of claim 13, where the disengaging further comprises:
performing one or more volume dismounting operations; and
automatically disconnecting the portable device from the host system.

17. A portable device, comprising:
a mechanical actuator operable for detecting input at a portable device; and
an interface coupled to the mechanical actuator and operable for initiating generation of a signal indicative of the touch input, and presenting the signal to a host system engaged to the portable device, where the signal is used to automatically initiate one or more operations related to disengaging the portable device from the host system.

18. The device of claim 17, where the portable device is from a group of portable devices including: Universal Serial Bus (USB) flash drives, SD cards, mobile phones, media players, game consoles, computer peripherals, biometric sensors, keypads, headsets, time pieces or other wearable items, pointing devices, computer input devices, touch pads, touch screens, key chains and multi-touch surfaces.

19. The device of claim 17, wherein the mechanical actuator is a button or switch.

20. The device of claim 17, where the disengaging further comprises:
performing one or more volume dismounting operations; and
automatically disconnecting the portable device from the host system.
